(19) United States
(12) Patent Application Publication
(10) Pub. No.: US 2015/0007214 A1
(43) Pub. Date: Jan. 1, 2015

(54) Method For Sending A Portion Of A Video Stream

(71) Applicant: Alcatel-Lucent USA Inc., Murray Hill, NJ (US)

(72) Inventors: Glenn R. Bruns, Naperville, IL (US); Bruce R. Cilli, Atlantic Highlands, NJ (US); Atul Divekar, Naperville, IL (US); Charles R. Payette, Oceanport, NJ (US)

(73) Assignee: ALCATEL-LUCENT USA INC., Murray Hill, NJ (US)

(21) Appl. No.: 13/930,405

(22) Filed: Jun. 28, 2013

(51) Int. Cl. H04N 21/234; H04N 21/25; H04N 21/266; H04N 21/233

(52) U.S. Cl. CPC H04N 21/234; H04N 21/233; H04N 21/25; H04N 21/266
USPC 725/29; 725/116

(57) ABSTRACT

A Wireless Service Provider (WSP) receives a request for a video stream from a user device. The WSP determines if the video stream should have the video portion modified or removed, based upon a user's manual request or a predetermined condition being met. The modification can be removal of the video portion or the replacement of the original video portion with a lower bandwidth video portion. The modified video stream is then sent to the user device.

### FIELD OF THE INVENTION

The present invention relates generally to communication systems.

### BACKGROUND OF THE INVENTION

Wireless data traffic has increased greatly in recent years and is projected to grow rapidly. Video traffic will continue to be the biggest drain on wireless network resources. This is obviously an issue for the Wireless Service Provider (WSP), and reducing the impact of carrying video over a wireless network is desirable. At the same time, heavy video users are also confronted with limits on their monthly data accounts. Anything that can reduce their consumption of data bits is desirable.

Many users utilize their wireless devices as media players. In particular, many wireless users utilize video websites to listen to music provided by the website. In order to hear the music, the user receives both the audio and video from the website in order to listen to the music. This is a huge usage of network resources, which not only consumes network resources but also utilizes a large portion of a user's data plan. And this comes at a time when more network providers are providing limited data plans, which do not allow users to utilize unlimited data bandwidth.

Therefore, a need exists for a way of providing wireless users with desired content without utilizing too much of their data plans. In addition, a need exists for WSPs to provide desired content without bogging down their networks and without requiring the need to build out their networks to provide additional bandwidth.

### BRIEF SUMMARY OF THE INVENTION

An exemplary embodiment of the present invention provides a method that allows for a WSP to provide a user with a mechanism to request that only the audio portion of a video feed be transmitted to the requesting user. The video stream, which includes both audio and video, is routed to a filtering device in the WSP's network that strips out the video content and forwards only the audio content. Alternately, a user can request that a lower bandwidth video portion is returned to the user so that less data is used by the requester.

An exemplary embodiment works as follows. A user's device settings menu provides an interface to the user to indicate whether an audio-only feed is desired for a particular application or website, for example YouTube. In an alternate exemplary embodiment, applications or websites themselves supply such an interface. In a further exemplary embodiment, instead of the WSP transcoding the video, YouTube provides an interface to notify it to send audio only for this particular instance. For example, a user registers with the WSP that he wants audio only under certain conditions, for example during times of network congestion or when the user is near or over his monthly data allowance. The WSP notifies the user when this condition is met. Thereafter, until cancelled, when the user starts YouTube his preference for audio-only is sent with the video request. Of course, the user could simply select audio-only in the YouTube app at any time.

In accordance with a further exemplary embodiment, a user initially sets his preferences with the WSP. When predetermined conditions are met, the WSP server tells the filtering device. In this exemplary embodiment the filtering device detects and intercepts the video request from the user and modifies the request to be audio-only and passes it along to the website or server, such as YouTube. Alternately, the filtering device specifies audio-only to the website or server via a RESTful API.

In turn, the WSP provisions a filtering device to route data traffic from the specified application provider or server to a transcoding device that strips the video content from the data stream and forwards the audio content. This provisioning is preferably done in advance based on the user settings, or alternately may be done in real-time, for example via a RESTful API, when triggered by the user that is currently viewing, or at least receiving, a video from an application.

In an alternate exemplary embodiment, lower bandwidth content replaces the video content of the video stream. This lower bandwidth content can comprise a visual pattern, the lyrics to an associated song, a picture or photograph, or the like.

In a further exemplary embodiment, a user can subscribe to a service where video content is either removed or reduced to a lower bandwidth only when certain predetermined conditions are met. For example, the predetermined conditions may include network congestion or a determination that the requesting user device, such as a mobile unit, is traveling faster than a predetermined threshold. In this case, the assumption is that the user of the user device is traveling in a vehicle, and any video content could distract the driver of the vehicle. In such a scenario, the video is removed prior to sending the stream to the requesting user.

### BRIEF DESCRIPTION OF THE SEVERAL VIEWS OF THE DRAWINGS

FIG. 1 depicts the functional architecture of a communication network in accordance with an exemplary embodiment of the present invention.

FIG. 2 depicts a call flow diagram in accordance with an exemplary embodiment of the present invention.

### DETAILED DESCRIPTION OF THE INVENTION

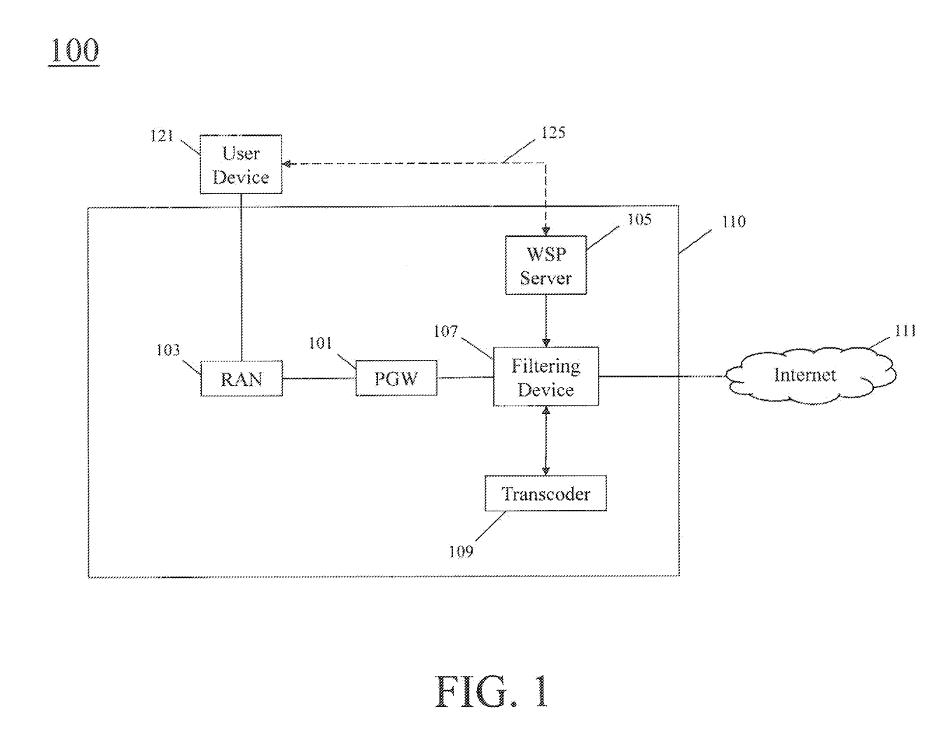

FIG. 1 depicts the functional architecture of communication network 100 in accordance with an exemplary embodiment of the present invention. Communication network 100 includes Wireless Service Provider (WSP) network 110, user device 121, and Internet 111.

WSP network 110 preferably includes PDN (Packet Data Network) Gateway (PGW) 101, Radio Access Network (RAN) 103, WSP Server 105, Filtering Device 107, and Transcoder 109.

PGW 101 preferably performs policy enforcement, packet filtering for each user, charging support, lawful interception and packet screening. PGW 101 can also act as the anchor for mobility between 3GPP and non-3GPP technologies such as WiMAX and 3GPP2, i.e., CDMA 1X and EvDO.

RAN 103 implements a radio access technology. RAN 103 preferably couples user device 121 with WSP network 110.

WSP Server 105 is responsible for receiving user requests to filter out video for a specific application. In accordance with an exemplary embodiment, a user of user device 121 starts an application and the settings for that application are received at WSP server 105, which in turn configures the settings on filtering device 107. WSP 110 routes all streams from the content provider, such as Internet 111, to filtering device 107.

Filtering Device 107 selectively routes the video stream requested by the user device to transcoder 109 according to the settings configured above.

Transcoder 109 removes the video content from audio/video streams. In an exemplary embodiment, multimedia streams are packaged into containers, such as MP4, FLV, 3GP, that preferably encode the audio and video components in an object oriented format synchronized with the time base. Transcoder 109 preferably parses the format headers to identify the video data boundaries and removes it. Transcoder 109 also makes necessary updates to the headers to reflect the changed content.

User device 121 is a wireless communication device that can communicate with WSP network 110. Depending on the standard, mobile phones and other wireless connected devices are varyingly known as user equipment (UE), terminal equipment, mobile station (MS), etc.

User device 121 preferably includes a subscriber identity module or subscriber identification module (SIM), which is an integrated circuit that securely stores the IMSI and the related key used to identify and authenticate subscribers on user device 121.

User device 121 can be a mobile device, such as a cell phone or smart phone, but may alternately be a device or sensor in a Machine-to-Machine (M2M) communication, or the device or sensor of the Internet of Things (IoT).

Interface 125 between user device 121 and WSP network 110 is preferably a “RESTful” API, typically implemented as messages in the XML format over the HTTP protocol used for web traffic. Interface 125 preferably sends data to WSP Server 105 via RAN 103 and PGW 101.

Internet 111 is a global system of interconnected computer networks that use the standard Internet protocol suite (TCP/IP) to serve several billion users worldwide. Internet 111 is a network of networks that includes millions of private, public, academic, business, and government networks, of local to global scope, that are linked by a broad array of electronic, wireless and optical networking technologies. Internet 111 carries an extensive range of information resources and services, such as the inter-linked hypertext documents of the World Wide Web.

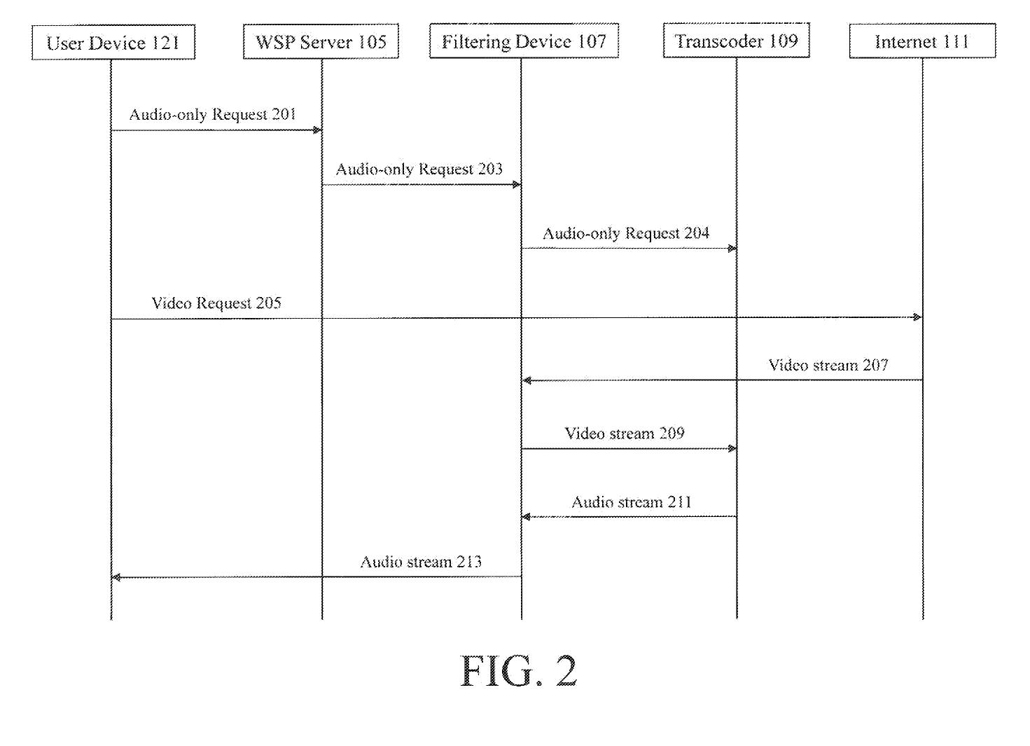

FIG. 2 depicts a call flow diagram 200 in accordance with an exemplary embodiment of the present invention. In accordance with an exemplary embodiment, user device 121 turns on the video filtering service by alerting WSP server 105. Alternately, indicates that it will accept filtering of video only when WSP network 110 detects congestion in the network. In a further exemplary embodiment, video content is filtered based upon policy. For example, video may be removed from a stream when it is determined that user device 121 is being used in a vehicle, making the video content not only be unnecessary but dangerous. This is preferably done after calculating the speed at which user device 121 is travelling. In a further exemplary embodiment, video content is filtered after a determination that the display is not currently powered on or is not functional. Still further, video content can be filtered when it is determined that the user device is currently locked. Additionally, video content can be filtered when it is determined that a user of user device is not currently watching the display utilizing recognition technology.

The user, or an application on user device 121, requests the video stream from application server 105 by sending Audio-only Request 201 to WSP Server 105. WSP server 105 routes all streams from the content provider to filtering device 107.

WSP Server 105 sends Audio-only Request 203 to Filtering Device 107.

Filtering Device 107 sends Audio-only Request 204 to Transcoder 109.

User Device 121 sends Video Request 205 to Internet 111.

Internet 111 sends Video stream 207 to Filtering Device 107.

Filtering Device 107 is aware of the request to remove video from the requested stream, and so sends Video stream 209 to Transcoder 109. In an alternate exemplary embodiment, Filtering Device 107 may default to filtering video from all audio/video requests and allow video to be transmitted only of specifically requested by the user or based upon an individual user's settings.

Transcoder 109 sends Audio stream 211 to Filtering Device 107. Audio stream 211 includes the audio portion of Video stream 209 without the video portion of Video stream 209. In accordance with an exemplary embodiment, Transcoder 109 removes the video content by packaging the multimedia streams into containers, such as MP4, FLV, or 3GP. The containers encode the audio and video components in an object oriented format synchronized with the time base. Transcoder 109 preferably parses the format headers to identify the video data boundaries and removes the video. Transcoder 109 also preferably makes necessary updates to the headers to reflect the changed content.

In accordance with an exemplary embodiment, Transcoder 109 replaces the existing video content of Video stream 209 with low-bandwidth video content. For example, for a music video, the original video could be replaced with a simple, moving visual pattern or song lyrics.

Filtering Device 107 sends Audio stream 213 to User Device 121.

An exemplary embodiment therefore reduces bandwidth consumption for WSPs, which leads to reductions in resource allocation and capital expenditure. By filtering the video from a downloaded data stream, users reduce bandwidth usage for intended music streams. This allows the user to download more desired data within their monthly data plan, and/or pay less for a particular quantity of desired data.

While this invention has been described in terms of certain examples thereof, it is not intended that it be limited to the above description, but rather only to the extent set forth in the claims that follow.

We claim:

1. A method for sending a portion of a video stream, the method comprising:
receiving a request for a video stream, the video stream comprising a video portion and an audio portion;
filtering the video portion from the video stream; and
sending the audio stream.

2. A method for sending a portion of a video stream in accordance with claim 1, wherein the step of filtering the video portion from the video stream occurs based upon congestion within the network exceeding a predetermined threshold.

3. A method for sending a portion of a video stream in accordance with claim 2, wherein the step of filtering the video portion from the video stream occurs based upon congestion within the network exceeding a predetermined threshold comprises filtering the video portion from the video stream

4. A method for sending a portion of a video stream in accordance with claim 1, wherein the step of filtering the video portion from the video stream occurs when the requester is traveling faster than a predetermined threshold.

5. A method for sending a portion of a video stream in accordance with claim 1, wherein the request for a video stream comprises a request for only the audio portion of the video stream.

6. A method for sending a portion of a video stream in accordance with claim 1, wherein the step of filtering the video portion from the video stream occurs based upon a determination that a screen associated with a user device that generated the request is currently locked.

7. A method for sending a portion of a video stream in accordance with claim 1, wherein the step of filtering the video portion from the video stream occurs based upon a determination that a screen associated with a user device that generated the request is currently powered off.

8. A method for sending a portion of a video stream in accordance with claim 1, wherein the step of filtering the video portion from the video stream occurs based upon a determination that a user has exceeded a data quota.

9. A method for sending a portion of a video stream in accordance with claim 1, wherein the step of filtering the video portion from the video stream occurs based upon a determination that a user has exceeded a predetermined percentage of a data quota.

10. A method for sending a portion of a video stream in accordance with claim 1, wherein the step of filtering the video portion from the video stream occurs based upon a determination that a user is not currently watching a display on a requesting user device.

11. A method for sending a modified video stream, the method comprising:
receiving a request for a first video stream, the video stream comprising a first video portion and an audio portion, wherein the first video portion has a first bandwidth;
replacing the first video portion with a second video portion to make a second video stream, wherein the second video portion has a second bandwidth that is lower than the first bandwidth; and
sending the second video stream.

12. A method for sending a modified video stream in accordance with claim 11, wherein the first video portion comprises a music video, and wherein the second video portion comprises music lyrics associated with the music video.

13. A method for sending a modified video stream in accordance with claim 11, wherein the first video portion comprises a music video, and wherein the second video portion comprises a moving visual pattern.

14. A method for sending a modified video stream in accordance with claim 11, wherein the step of replacing the first video portion with a second video portion comprises replacing the first video portion with a second video portion when the requester is traveling faster than a predetermined threshold.

15. A method for sending a modified video stream in accordance with claim 11, wherein the step of replacing the first video portion with a second video portion occurs based upon congestion within the network exceeding a predetermined threshold.

16. A method for sending a modified video stream in accordance with claim 15, wherein the step of replacing the first video portion with a second video portion based upon congestion within the network exceeding a predetermined threshold comprises replacing the first video portion with a second video portion only when a user has requested video replacement.

17. A method for sending a modified video stream in accordance with claim 11, wherein the step of replacing the first video portion with a second video portion comprises replacing the first video portion with a second video portion based upon a determination that a screen associated with a user device that generated the request is currently locked.

18. A method for sending a modified video stream in accordance with claim 11, wherein the step of replacing the first video portion with a second video portion comprises replacing the first video portion with a second video portion based upon a determination that a user has exceeded a data quota.

19. A method for sending a modified video stream in accordance with claim 11, wherein the step of replacing the first video portion with a second video portion comprises replacing the first video portion with a second video portion based upon a determination that a user has exceeded a predetermined percentage of a data quota.
